(19) United States
(12) Patent Application Publication
(10) Pub. No.: US 2011/0108385 A1
(43) Pub. Date: May 12, 2011

(54) COIN-OPERATED LOCK

(75) Inventors: Ake Haggstrom, Lycksele (SE); Rolandh Jonsson, Lycksele (SE)

(73) Assignee: ASSA AB, Eskilstuna (SE)

(21) Appl. No.: 12/772,337

(22) Filed: May 3, 2010

(30) Foreign Application Priority Data
May 6, 2009 (SE) 0950316-0

(51) Int. Cl. G07F 5/02; E05B 19/00

(52) U.S. Cl. 194/247

(57) ABSTRACT

Coin-operated lock comprising a lock housing (1), a lock cylinder having a cylinder core (50), a bolt piece (3), and a follower (4), which is rotatable about a rotational axis and is coupled to the cylinder core and the bolt piece to allow operation of the bolt piece by means of a key inserted in the cylinder core. In the absence of a coin inserted in the lock housing, a blocking device (6, 7) prevents movement of the bolt piece. A decoupling device is designed to decouple the blocking device. The decoupling device comprises a driver (20) and a coupling member (30). The driver is arranged radially outside the follower (4), rotatably about the rotational axis of the follower, and comprises a decoupling member (21, 22) designed to decouple the blocking device. The coupling member (30) is arranged on the follower so that it is radially displaceable between an inner position and an outer position, and comprises an inner (35) and an outer (34) end. The coupling member is designed to be displaced, upon insertion of a service key (60) in the cylinder core and upon contact between the inner end and a code surface (65) arranged on the service key, from an inner to an outer position, in which outer position the outer end can engage with the driver in order to achieve, upon rotation, decoupling of the blocking device from the bolt piece.

### FIELD OF THE INVENTION AND BACKGROUND

The invention relates to a coin-operated lock and, more specifically, to a coin-operated lock of the type defined in the preamble to claim 1.

Coin-operated locks of this kind can be used, for example, in lockers and safe-deposit boxes in public premises such as sports centres, swimming baths, train stations, airports and the like.

The coin-operated locks can operate according to the deposit principle, in which the inserted coin is refunded after use, and/or according to the payment principle, in which the coin is not refunded.

The coin-operated locks can be configured to allow use after a single, two or sometimes more coins have been inserted through the coin opening or through a respective coin opening. Should two or more coins be required for use, the coin-operated locks can be configured so that coins of different value are required to allow use.

Especially where the coin-operated locks are configured to refund at least one coin after use, it may be desirable for the coin-operated locks to be configured with a so-called penalty function. The possibility is here given, through the use of a special service key, to operate the coin-operated lock even without one or more coins being placed in the lock. Such a penalty function is used, for example, where a user has retained the locker or the like on which the lock is disposed for longer than permitted by the owner or manager of the locker. The owner or manager can then, by means of the service key, unlock the coin-operated lock, seize it or the coins which are otherwise meant to be refunded, and thereafter relock the coin-operated lock without inserting a coin. In such coin-operated locks provided with a penalty function, the locks must therefore be configured to allow locking by means of a special service key, even without the insertion of a coin.

### PRIOR ART

EP 1 694 933 B1 describes a coin-operated lock which can be operated by means of a user key after a coin has been inserted into the lock. Through the use of a special service key, the lock cylinder, furthermore, can be detached and exchanged without removal of the lock. The coin-operated lock described in EP 1 694 933 B1 does not, however, have a penalty function and thus does not allow the coin-operated lock to be locked without a coin being inserted in the lock.

In another previously known coin-operated lock having a so-called penalty function, the coin-operated lock is allowed to be locked by means of a service key without a coin needing to be present in the lock. In this previously known coin-operated lock, a service key is utilized which is longer than a normal user key to allow locking without an inserted coin. The coin-operated lock comprises a release device which, through interaction with the rear side of a portion close to the tip of the lengthened service key bit, releases a blocking device which otherwise prevents locking of the coin-operated lock unless a coin is in a coin position in the lock that is intended for normal use.

### SUMMARY OF THE INVENTION

One object of the invention is to provide an improved coin-operated lock which allows operation, and especially locking, of the lock by means of a service key, even without a coin being in a coin position in the lock that is intended for normal use by means of a user key. Another object is to provide a coin-operated lock of this kind which allows simple recoding of the coin-operated lock.

A further object is to provide a coin-operated lock of this kind which allows the use of a service key in which a key code corresponding to the code of the lock is arranged on the customary code side of the key bit that lies opposite the back of the key.

Yet another object is to provide a coin-operated lock of this kind which is simple, secure and reliable.

These and other objects are met with a coin-operated lock of the type which is defined, in the preamble to claim 1 and which has the distinguishing features defined in the characterizing part.

The coin-operated lock according to the invention comprises a lock housing having a coin opening for the insertion of a coin, a lock cylinder having a cylinder core, and a bolt piece, which is connected to a bolt and is movable between a rear and a front position. A follower is rotatable about a rotational axis and is coupled to the cylinder core and the bolt piece to allow operation of the bolt piece by means of a key inserted in the cylinder core. In the absence of a coin inserted in the lock housing and in engagement with the bolt piece, a blocking device prevents movement of the bolt piece from the rear to the front position. A decoupling device is designed to decouple the blocking device from the blocking step to allow displacement of the bolt piece from the rear to the front position even in the absence of a coin inserted in the lock housing. According to the invention, the decoupling device comprises a driver and a coupling member. The driver is arranged radially outside the follower and rotatably about the rotational axis of the follower and comprises a decoupling member designed to decouple the blocking device. The coupling member is arranged on the follower so that it is radially displaceable between an inner position and an outer position, and comprises an inner and an outer end. The coupling member is further designed to be displaced, upon insertion of a service key in the cylinder core and upon contact between the inner end and a code surface arranged on the service key, from an inner to an outer position, in which outer position the outer end can engage with the driver in order to produce, upon rotation of the service key and the follower, a corresponding rotation of the driver and the decoupling member in order to achieve decoupling of the blocking device from the bolt piece.

With the thus configured decoupling device, a coin-operated lock is provided, which, through adjustment of the distance from the inner to the outer end of the coupling member, can be easily given a code corresponding to an intended service key.

The follower and the coupling member are expediently configured to achieve, upon insertion of the service key in the cylinder core, contact between the inner end of the coupling member and a code surface arranged on a side, lying opposite the service key back, of the key bit. This enables the service key to be given a desired code, intended for interaction with the coin-operated lock, through conventional code processing of the customary code side of the service key.

The cylinder core, the follower and the coupling member are expediently configured to achieve, upon insertion of the key in the cylinder core, contact between the inner end of the coupling member and a code surface arranged close to the key tip. The coupling member is here expediently arranged at a distance from the feed-in mouth of the cylinder core, which distance exceeds the length of the key bit of an intended normal user key. The service key can hereby differ from the user key by way of a portion which is lengthened at the key tip, which lengthened portion has the code surface intended to achieve decoupling.

The driver expediently comprises a first and a second stop for engagement with the outer end of the coupling member. The two stops are configured to engage successively, one after the other, with the coupling member when the follower is rotated. This makes it possible, inter alia, for rotation to be imparted to the follower at a greater angle of rotation than the angle of rotation for the rotation of the driver.

The coupling member is expediently resiliently compressible in an axial direction between the inner and outer end. This makes it easily possible for the coupling member, upon rotation of the follower, first to engage with the first stop and drive the driver to rotate over a certain distance so as subsequently to be forced out of this engagement and, upon continued rotation of the follower, engage with the second stop in order to produce continued rotation of the driver.

The coupling member is expediently received in a limitedly displaceable manner in a radial bore made in the follower. A simple construction is hereby achieved, which allows simple mounting of the coupling member on the follower and which simultaneously prevents the coupling member from sliding out of the bore and preventing insertion of the service key.

The coin-operated lock can be configured as a so-called two-track lock, in which insertion of a first and a second coin is required for operation by means of a user key. The coin-operated lock in this case expediently comprises a first and a second blocking device, which in the absence of a first and second coin inserted in the lock housing, in engagement with the bolt piece, prevents movement of the bolt piece from the rear to the front position, and a first and second decoupling member, arranged on the driver, for decoupling the first and second blocking device from the bolt piece.

Further advantages and characteristics of the coin-operated lock according to the invention emerge from the following detailed description of illustrative embodiments and of the claims.

### BRIEF DESCRIPTION OF THE FIGURES

A description of illustrative embodiments of the invention is given below with reference to the figures, whereof:

FIG. 1 is a plan view, from the outside, of a coin-operated lock according to one embodiment of the invention,

FIG. 2 is a schematic plan view corresponding to that in FIG. 1, with certain parts removed,

FIGS. 3 and 4 are perspective views, obliquely from one side, of certain component parts of the embodiment shown in FIGS. 1 and 2 with an inserted service key, and shows these parts in a first and second position,

FIG. 5 is a perspective view corresponding to those in FIGS. 3 and 4, but from the other side and showing the parts in a third position,

FIG. 6 is a perspective view corresponding to that in FIGS. 3 and 4, which shows the parts in interaction with further parts of the coin-operated lock when the parts are in a fourth position,

FIG. 7 is a partially transparent plan view, on an enlarged scale, of one of the parts shown in FIGS. 3-6,

FIG. 8 is a plan view which shows the part shown in FIG. 7 in interaction with the key bit of a service key,

FIG. 9 is a sectional view showing some of the parts shown in FIGS. 3-6.

### DETAILED DESCRIPTION OF ILLUSTRATIVE EMBODIMENTS

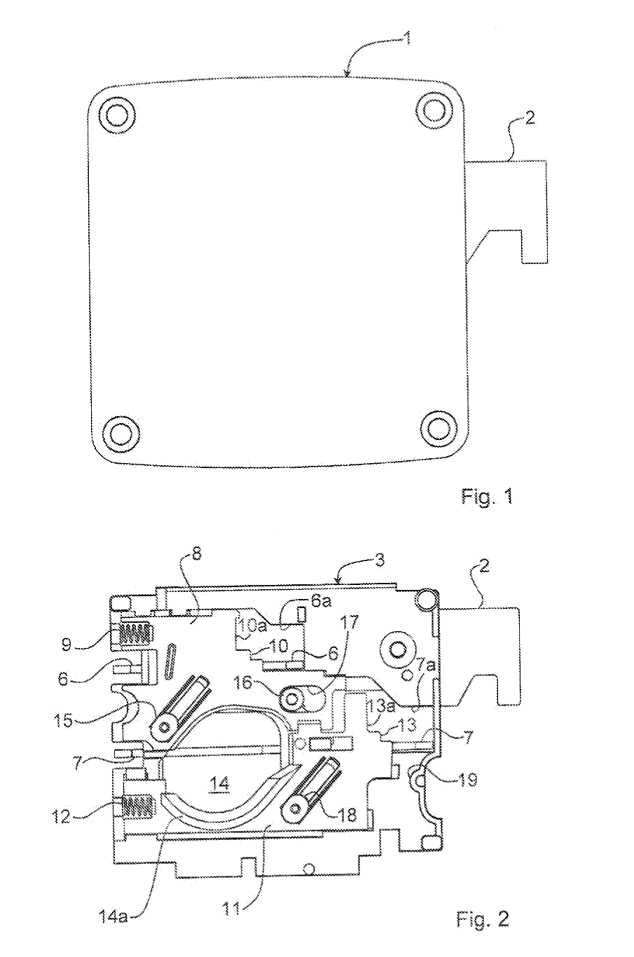

In FIG. 1 is shown the outer side of a coin-operated lock according to one embodiment of the invention. The illustrative coin-operated lock is of the so-called two-track type and can be operated by means of a user key after the insertion of two coins. The coin-operated lock comprises a lock housing 1 or lock casing, and a bolt, which in the shown example is constituted by a hook bolt. On its, in the figure, upper edge face, the lock housing is provided with two mutually aligned, elongated coin openings (not shown) for insertion of a first and a second coin.

In FIGS. 2-6 are shown certain inner parts of the coin-operated lock once the lock housing is removed. As can be seen from FIG. 2, a bolt piece 3 is arranged so that it is movable between a rear and a front position. The bolt 2 is fixedly connected to the bolt piece 3 and is movable relative to the lock housing together with the bolt piece 3.

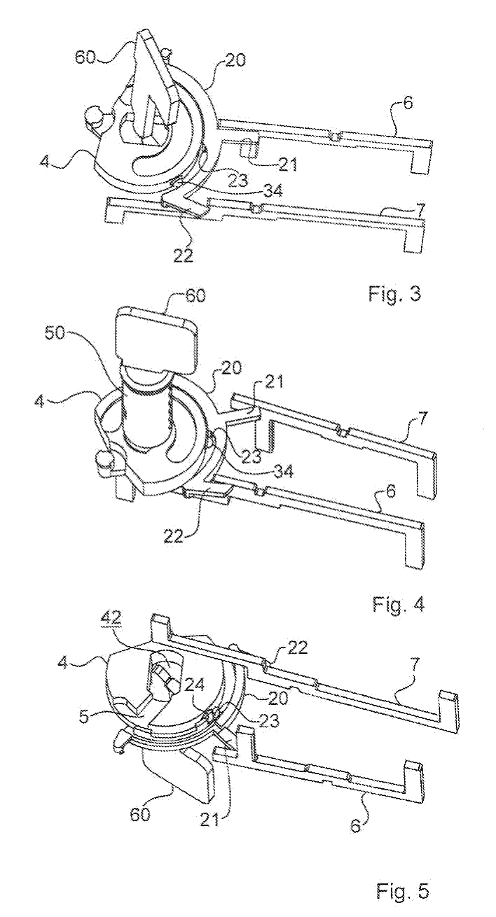

A follower 4 shown in FIGS. 3-6 has a groove 5 (FIG. 5). The bolt piece 3 comprises a lug (not shown), which is received in the groove 5 of the follower 4. The follower is in this way connected to the bolt piece 3. The lock housing 1, the bolt piece 3, the bolt 2 and the follower 4 are configured so that rotation of the follower in a locking direction first produces a substantially horizontal displacement of the bolt 2 and the bolt piece 3 towards a front, extended position, and thereafter a substantially vertical downward displacement of both the bolt 2 and the bolt piece 3, whereupon the bolt 2 can engage with a striking plate (not shown) or the like. Rotation of the follower 4 in an opposite unlocking direction produces, correspondingly, first a vertical upward displacement of the bolt 2 and the bolt piece 3 and, thereafter, a horizontal displacement towards a rear, retracted position of the bolt 2 and the bolt piece 3.

The bolt piece 3 further has a first and a second stepped detent (not shown), each of which has a number of detent steps. A first 6 and a second 7 blocking device in the form of a first and second hook are rotatably fixed to the lock housing 1 and are arranged to engage, in a respective lowered position, with the bolt piece 3 at the first and second stepped detent, so that displacement of the bolt piece 3 in the direction of the front position is prevented.

A first, upper slide 8 is arranged on the bolt piece 3, on one side thereof. The first slide 8 is limitedly displaceable in relation to the bolt piece 3 in the horizontal direction. A first spring 9 is arranged between the bolt piece 3 and the first slide 8 so as to return the slide 8 to its starting position relative to the bolt piece 3 once it has been displaced relative to the bolt piece 3. The first slide 8 has a stepped detent 10 with a number of detent steps and an upper, vertical stop 10a.

A second, lower slide 11 is arranged correspondingly on the bolt piece 3, on the same side of the bolt piece as the first slide 8. The second slide 11, like the first 8, is limitedly displaceable relative to the bolt piece 3 in the horizontal direction. A second spring 12 is arranged between the bolt piece 3 and the second slide 11, so as to return the second slide 11 to its starting position relative to the bolt piece 3 once it has been displaced relative to the bolt piece 3. The second slide 11 also has a stepped detent 13, having a number of detent steps, and an upper, vertical stop 13a.

The bolt piece 3 also has a continuous opening 14, and the second slide 11 comprises a guide flange 14a, which protrudes in the direction out from the bolt piece 3 and is arranged outside the continuous opening 14 in the bolt piece 3.

The coin-operated lock comprises a first and a second coin-detecting device. The first coin-detecting device comprises the first blocking device 6, a first supporting member 15, which is fixed, to the first slide 8, and a second supporting member 16, which is fixed to the bolt piece 3 and which extends through a slot 17 made in the first slide 8. The second coin-detecting device comprises the second blocking device 7, a first supporting member 18, which is fixed to the second slide 11, and a second supporting member 19, which is fixed to the bolt piece 3.

FIG. 4 further illustrates that the follower 4 is coupled to a cylinder core 50 forming part of a lock cylinder (otherwise not shown). In FIG. 4, a service key 60 is shown in inserted position in the cylinder core 20. In FIGS. 3, 5, 6 and 9, the service key is shown in the inserted position, but with the cylinder core removed, for increased clarity.

As can be seen from FIGS. 3-6, the coin-operated lock further comprises a decoupling device for enabling the lock to be operated by means of a service key 60 even when there is no coin present in the lock housing. The decoupling device comprises a driver 20, arranged radially outside and partially around the follower 4, as well as a coupling member 30.

The driver 20 is rotatable about the rotational axis of the follower 4. The driver comprises a first 21 and a second 22 decoupling member, protruding radially outwards, which decoupling members 21, 22 are designed to lift the first 6 and second 7 blocking device upon rotation of the driver 20 so that they escape from the stepped detents on the bolt piece and the stepped detents 10, 13 on the respective slide 8, 11. The driver further has a first 23 and a second 24 stop, which are arranged on a curved, follower-facing side of the driver.

The coupling member 30 (see also FIGS. 7-9) forms an axially compressible pin. The coupling member comprises a sleeve-shaped female part 31, having a flange 32 protruding at the open end. A cylindrical male part 33 is received by its one end in the female part 31. The male part 33, on its end protruding from the female part, has an end portion in the shape of a hemisphere, which end portion constitutes an outer end 34 of the coupling member 30. The female part 31, on the end opposite lying opposite the male part, has a conically shaped end portion, which constitutes an inner end 35 of the coupling member 30. A compression spring 36, which presses the male part 33 in the outward direction, is received in the female part 31. The male part 33 further has a stop face 37, which is facing the female part 31 and which, upon compression, by bearing contact, against a male-part-facing surface 38 of the flange 32, limits the mobility of the male part 33 in the direction of the female part 31.

As can most clearly be seen from FIG. 9, the coupling member 30 is received in a radial bore 41 arranged in the follower 4. The coupling member 30 is displaceable in the radial direction of the follower 4. The bore 41 emerges with its inner end in a central opening 42 in the follower and with its outer end on the outer shell surface 43 of the follower. The bore 41 has a stop 44, against which the flange 32 of the female part 31 of the coupling member 30 can rest to prevent the coupling member 30 from being led too far in the direction inwards towards the rotational axis of the follower. In this way, the coupling member can be easily mounted on the follower 4 by being led radially into the bore 41 from outside. In the mounted position, the coupling member 30 is prevented from sliding out of the bore by the driver 20 arranged radially outside the shell surface of the follower 4.

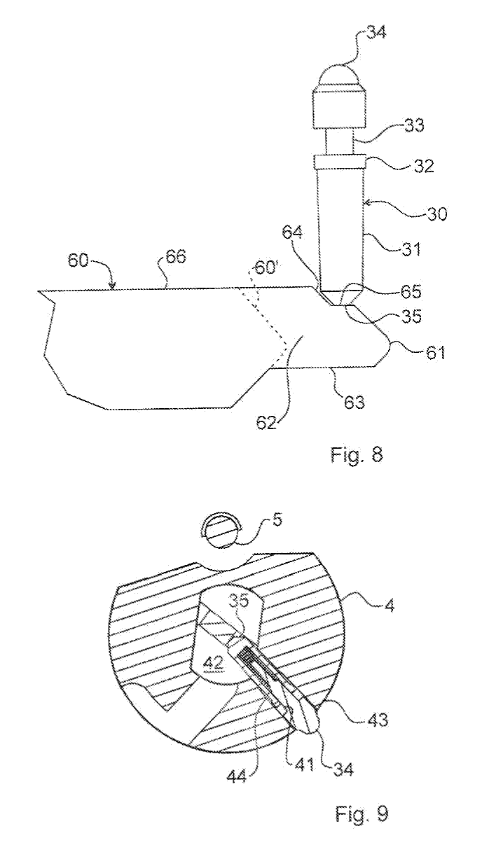

FIG. 8 illustrates schematically how the bit of a specially configured service key 60 interacts with the coupling member 30. The figure also shows schematically, with dashed lines 60′, the tip of the bit of a normal user key which can be used to operate the coin-operated lock after the insertion of coins. As can be seen from the figure, the bit of the service key 60 is longer than the bit of a corresponding user key 60′. The bit of the service key thus has close to the key tip 61a lengthened bit portion 62. The lengthened bit portion 62 has a back portion 63, which is recessed in relation to the rest of the bit and allows the lengthened bit portion 62 to be inserted in the central opening 42 in the follower (see FIGS. 5 and 9). The lengthened bit portion 62 further has a code portion 64 lying opposite the recessed back portion 63. This code portion is thus arranged on the code side or code edge, which is customary for this type of key, of the bit, which means that a coding specific to the service key can be easily achieved in the accepted manner by machining of this side of the lengthened bit portion 62. In the shown example, a code surface 65 has been produced by mill-cutting that side of the lengthened bit portion 62 which lies opposite the back portion 63 to a certain depth. It will be appreciated that the service key can thus be easily coded in the customary manner by milling a key blank to a desired code depth which can be chosen from, for example, four standardized possible code depths. It will also be appreciated that that portion 66 of the bit of the service key which is arranged on that portion of the lengthened bit portion 62 which lies opposite the tip 61 is expediently given a main key coding, so that the service key 60 can be used to unlock all coin-operated locks which form part of a stock.

The working of the coin-operated lock illustrated in the figures will be described below. In normal use by means of a user key, a first coin is inserted into the first coin opening and a second coin is inserted into the second coin opening. In the figures, an application is shown in which the distance between the first 15 and the second supporting member 16 of the first coin-detecting device is as large as the corresponding distance of the second coin-detecting device, and in which the inserted coins must thus have the same diameter and value. It will be appreciated, however, that the distance between the supporting members 15, 16 of the first coin-detecting device can differ from the distance between the supporting members 18, 19 of the second coin-detecting device, in order thereby to allow the coin-operated lock to be used only if two coins of different minimum diameter are inserted into a respective coin opening intended therefor.

When the coins are inserted through the respective coin opening, one coin drops down and comes to bear against the first 15 and second 16 supporting member of the first coin-detecting device. The other coin drops down and comes to bear against the first 18 and second 19 supporting member of the second coin-detecting device. If the follower 4, by means of a key inserted in the lock cylinder and the cylinder core 50, is rotated in this position in the locking direction, the bolt piece 3 and the two slides 8 and 1 will be slightly displaced horizontally towards the front position. Upon this horizontal displacement, the two blocking members 6, 7 will slide along the respective peripheral surface of the coins, so that the blocking members 6, 7 escape from the stepped detents 10, 13 on the first 8 and second 11 slide, as well as from the stepped detents on the bolt piece 3. The bolt piece 3 and the two slides 8, 11 are thus allowed continued displacement towards the front position.

Upon the continued displacement, the blocking members will come to bear against the respective upper, vertical stop 10a, 13a of the first 8 and second 11 slide. The two slides 8, 11 are thereby prevented from continued displacement, whilst the bolt piece 3 is displaced further towards the front position. The distances between the first 15, 18 and second 16, 19 supporting members of the first and second coin-detecting device are thereby widened, so that the coins can drop down between their respective supporting members. During this relative motion between the bolt piece 3 and the first 8 and second 11 slide, the two springs 9, 12 are compressed.

Continued rotation of the follower 4 in the locking direction thereafter imparts a vertical downward motion to the bolt piece 3 and the bolt 2, so that the bolt can engage with a striking plate or the like and assume its front, locked position.

When the first coin drops down between the supporting members 15, 16, it butts against the protruding flange 14a and is thereby led in through the continuous opening 14 in the bolt piece 3. After this, the first coin is led down to an entrance to a pay coin receptacle (not shown) arranged below the lock housing 1, which entrance is arranged on that side of the bolt piece 3 which lies opposite the supporting members 15, 16, 18, 19, and below this bolt piece. The second coin drops down between the supporting members 18, 19 to a return coin receptacle (not shown) arranged below these, where it can be retrieved by the user. The coin-operated lock is expediently arranged on the inner side of, for example, a locker door or the like, whereby the return coin can only be retrieved after the coin-operated lock has been unlocked again and the locker door has been opened.

If an attempt is made to lock the coin-operated lock by means of a user key without first inserting coins of the intended dimension, the blocking devices 6, 7, in bearing contact against and in engagement with the stepped detents on the bolt piece 3 and the slides 8, 11, will prevent displacement of the bolt piece 3 and the slides 8, 11, in which case it is not possible to achieve locking of the coin-operated lock.

When the coin-operated lock is to be unlocked by means of a correct user key or a service key 60 provided with a main key code, the follower 4 is rotated by means of the key in the opposite unlocking direction, whereupon the bolt 2 and the bolt piece 3 are first lifted vertically upwards so that the bolt is disengaged from the striking plate. Continued rotation of the follower 4 in the unlocking direction thereafter imparts to the bolt 2 and the bolt piece 3 a horizontal displacement in the direction of the rear position. Upon this displacement, the springs 9, 12 press the two slides 8, 11 into their respective starting positions relative to the bolt piece 3. After this, the blocking members 6, 7 slide gradually down the stepped detents 10, 13 on the slides 8, 11 and the stepped detents on the bolt piece 3, without preventing the displacement of the bolt piece 3 and the two slides 8, 11 back to the rear position.

When the coin-operated lock is to be locked by means of the service key 60 without the insertion of a coin, the service key 60 is inserted into the lock cylinder and the cylinder core 50. The lengthened bit portion 62 of the service key will hereupon be led into the central opening 42 in the follower 4. As can most clearly be seen in FIGS. 5, 8 and 9, upon insertion of the service key 60 the key tip, in contact with the inner end 35 of the coupling member 30, will press the coupling member 30 radially outwards relative to the follower 4. Upon rotation of the cylinder core 50 and the follower 4 from the position shown in FIG. 3 to that shown in FIG. 4, the coupling member 30, in the extended position relative to the follower 4, will be rotated so that its outer end 34 comes to bear against the first stop 23 on the driver. Upon continued rotation of the follower 4, the coupling member 30 is engaged by its outer end 34 with the first stop 23, the driver being driven to rotate with the follower 4. During this rotation of the driver 20, the protruding decoupling members 21, 22 come into contact with the respective blocking members 6, 7 and lift these so that they escape from the stepped detents on the bolt piece, as well as the stepped detents 10, 13 on the two slides 8, 11. When the blocking members 6, 7 are lifted over a certain distance, the blocking members 6, 7 come into contact with the respective motion-limiting members 6a, 7a. In the shown example, these motion-limiting members are constituted by a first 6a and a second 7a stop face. In a non-illustrated embodiment, the two motion-limiting members are disposed, however, on an inner cover lid (not shown) arranged in the lock housing. Upon continued rotation of the follower 4, the blocking members 6, 7 are thus prevented from being lifted further, which prevents continued rotation of the driver 20. The male part 33 of the coupling member 30 will hereupon be pressed inwards in the female part 31 with the hemispherical outer end 34, while in bearing contact against the first stop 23 and while surmounting the spring force of the spring 36, so that the outer end 34 disengages from the first stop 23.

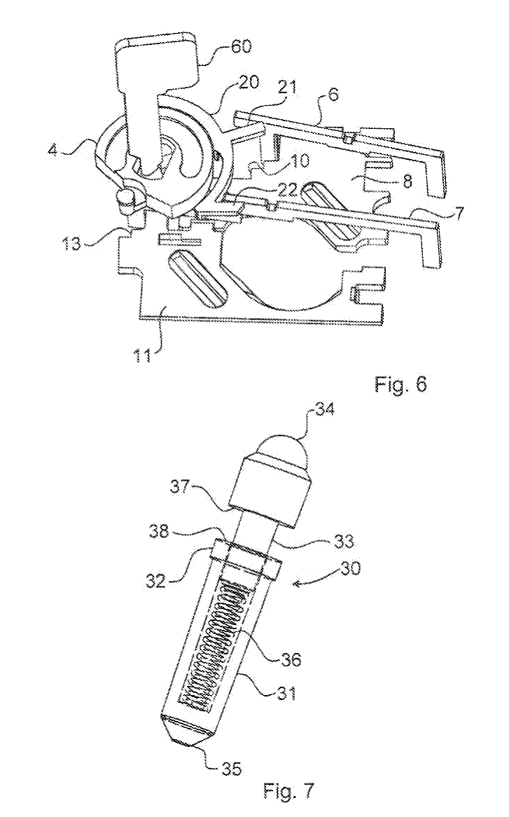

The outer end 34 of the coupling member 30 thereafter slides along a surface of the driver 20 which is facing the follower 4, until the outer end 34 can protrude into a recess in this surface, which recess is arranged on the second stop 24 of the driver (see FIG. 5). During this relative motion between the follower 4 and the driver 20, the blocking members 6, 7 can drop down from the motion-limiting members 6a, 7a. When the outer end 34 of the coupling member 30 protrudes into the recess and engages with the second stop 24, continued rotation of the follower again causes the driver and the decoupling members 21, 22 to once again lift the blocking members 6, 7 until they regain contact with the motion-limiting members 6a, 7a. During this continued motion, the blocking members 6, 7 have fully escaped from the stepped stops on the bolt piece 3 and the two slides 8, 11 (see FIG. 6). Upon further continued rotation of the follower 4, the driver 20, is prevented from rotating, as above, by the bearing contact of the blocking members 6, 7 against the motion-limiting members 6a, 7a. The male part 33 of the coupling member is then pressed back into the female part 31, whereupon the outer end 34 disengages from the second stop 24. The rotation of the follower in the locking direction can thereafter be completed, the outer end 34 of the coupling member sliding along that side of the driver which is facing towards the follower, so that the follower 4 can be rotated relative to the driver 20. During this multi-step rotation of the follower 4 and the driver 20, the bolt piece 3 and the slides 8, 11 can be freely displaced into the front, extended position and further downwards, so that the bolt assumes the position locked in engagement with the striking plate.

In this way, locking of the coin-operated lock by means of a service key provided with a lengthened bit portion is thus achieved without a coin being inserted in the coin-operated lock. The coin-operated lock according to the invention yields the advantage, inter alia, that the lock and the service key can be easily given different, mutually coordinated codes. The coin-operated lock is easily recoded by configuring the coupling member 30 with different length in the compressed state. This can be achieved, for example, by exchanging either the male 33 or female part 31 of the coupling member for corresponding parts having another length. The service key, for its part, can be easily coded in the customary manner by arranging the code surface 65 at a distance from the nominal code side of the key bit, which distance fits the code length of the coupling member.

Above, a description has been given of illustrative embodiments of the coin-operated lock according to the invention. It will be appreciated, however, that the invention is not limited to these illustrative embodiments, but can be freely varied within the scope of the following claims. For example, the coin-operated lock, instead of being configured for the insertion of two coins, can be configured for normal use after the insertion of just one coin. In this case, it is sufficient for the coin-operated lock to comprise, instead of two slides, just one slide, a coin-limiting device, a blocking device and a decoupling member arranged on the driver. Furthermore, the bolt, instead of being configured as a component fixed to the bolt piece, can be configured in one piece with the bolt piece. In the shown examples, the bolt is a hook bolt, but it will be appreciated that the bolt can instead be of straight type or any other suitable type. In addition, the motion of the bolt piece between the rear and front position can describe other motional paths than two successive rectilinear displacements. In the shown example the coin-operated lock is of right-handed design, though it will be appreciated that the coin-operated lock, through certain adaptations, can also be configured for left-handed design. The coin-operated lock can also be adapted, through the provision of suitable pay coin and/or return coin receptacles, to operate according to the payment and/or deposit principle.

1. Coin-operated lock comprising:
a lock housing having a coin opening for the insertion of a coin,
a lock cylinder having a cylinder core,
a bolt piece, which is connected to a bolt and is movable between a rear and a front position,
a follower, which is rotatable about a rotational axis and is coupled to the cylinder core and the bolt piece to allow operation of the bolt piece by means of a key inserted in the cylinder core,
a blocking device, which, in the absence of a coin inserted in the lock housing, in engagement with the bolt piece, prevents displacement of the bolt piece from the rear to the front position, and
a decoupling device designed to decouple the blocking device from the bolt piece to allow displacement of the bolt piece from the rear to the front position even in the absence of a coin inserted in the lock housing,
characterized in that
the decoupling device comprises:
a driver, which is arranged radially outside the follower and rotatably about the rotational axis of the follower and which comprises a decoupling member designed to decouple the blocking device, and
a coupling member, which is arranged on the follower so that it is radially displaceable between an inner position and an outer position and which comprises an inner and an outer end, which coupling member is designed to be displaced, upon insertion of a service key in the cylinder core and upon contact between the inner end and a code surface arranged on the service key, from an inner to an outer position, in which outer position the outer end can engage with the driver in order to produce, upon rotation of the key and the follower a corresponding rotation of the driver and the decoupling member in order to achieve decoupling of the blocking device.

2. Coin-operated lock according to claim 1, in which the cylinder core, the follower and the coupling member are configured to achieve, upon insertion of the service key in the cylinder core, contact between the inner end of the coupling member and a code surface arranged on a code side, lying opposite the key back, of the key bit of the service key.

3. Coin-operated lock according to claim 1, in which the cylinder core, the follower and the coupling member are configured to achieve, upon insertion of the service key in the cylinder core, contact between the inner end of the coupling member and a code surface arranged close to the key tip.

4. Coin-operated lock according to claim 1, in which the driver comprises a first and a second stop for engagement with the outer end of the coupling member.

5. Coin-operated lock according to claim 1, in which the coupling member is resiliently compressible in an axial direction between the inner and outer end.

6. Coin-operated lock according to claim 1, in which the coupling member is received in a limitedly displaceable manner in a radial bore made in the follower.

7. Coin-operated lock according to claim 1, comprising a first and a second blocking device, which in the absence of a first and second coin inserted in the lock housing, in engagement with the bolt piece, prevent movement of the bolt piece from the rear to the front position, and a first and second decoupling member, arranged on the driver, for decoupling the first and second blocking device from the bolt piece.
